(19) United States
(12) Patent Application Publication
(10) Pub. No.: US 2016/0234503 A1
(43) Pub. Date: Aug. 11, 2016

(54) Method for Determining a Corner Video Part of a Partition of a Video Coding Block

(71) Applicant: HUAWEI TECHNOLOGIES CO., LTD., SHENZHEN (CN)

(72) Inventor: JACEK KONIECZNY, MUNICH (DE)

(21) Appl. No.: 15/130,459

(22) Filed: Apr. 15, 2016

Related U.S. Application Data
(63) Continuation of application No. PCT/EP2013/071666, filed on Oct. 16, 2013.

(51) Int. Cl. H04N 19/14; H04N 19/103; H04N 19/129; H04N 19/593; H04N 19/11; H04N 19/17; H04N 19/182; H04N 19/46; H04N 19/167; H04N 19/107

(52) U.S. Cl. CPC H04N 19/14; H04N 19/167; H04N 19/103; H04N 19/129; H04N 19/107; H04N 19/11; H04N 19/17; H04N 19/182; H04N 19/46; H04N 19/593

(57) ABSTRACT

Embodiments provide a method for determining a corner video part of a partition of a video coding block, the video coding block comprising a plurality of video parts. The method includes selecting a video part of the video coding block according to a predetermined scanning pattern to obtain a selected video part, wherein the predetermined scanning pattern indicates a scanning order of the video parts in the video coding block. The method also includes determining whether the selected video part is arranged within the partition, and determining the selected video part as the corner video part if the selected video part is arranged within the partition.

This application claims priority to International Application No. PCT/EP2013/071666, filed on Oct. 16, 2013, which is hereby incorporated by reference in its entirety.

### TECHNICAL FIELD

The invention relates to the field of video coding.

### BACKGROUND

In modern video codecs, a video frame of a video signal can be divided into video coding blocks, also denoted as macro-blocks or coding units. In the coding process, a video coder can decide about whether to divide each video coding block into smaller partitions which is usually referred to as block partitioning. As a result, each video coding block can comprise a number of partitions.

When a predictive video coding scheme is employed for coding the video signal, a reference video coding block can be selected. The reference video coding block can be a video coding block which has previously been coded and enables determining a prediction deviation of the video coding block. The prediction deviation can then be signaled in the bit-stream of the coded video signal.

Analogously, the predictive video coding scheme can be applied to a partition of the video coding block, wherein a reference partition can be selected which has previously been coded. In this case, a prediction deviation of the partition can be determined and can be signaled in the bit-stream of the coded video signal.

For efficiently determining a reference partition, a corner video part of the partition can be used. The reference partition can then be determined with respect to the location of the corner video part of the partition. For determining a corner video part of the partition of the video coding block, a corner detection scheme can be employed.

In Bo Yu et al., “A Corner Detection Algorithm Based on the Difference of FCC”, ICCDA, June 2010, a corner detection scheme using chain codes and matching patterns is described.

In C. Harris et al., “A combined corner and edge detector”, Proc. 4th Alvey Vision Conference, 1988, a corner detection scheme using gradients in two orthogonal directions is described.

However, these corner detection schemes use complex computations like filtering of video parts and/or processing of all video parts of the partition. This can result in a non-negligible increase in computational complexity which can limit the performance of modern video codecs.

### SUMMARY

It is the object of the invention to provide an efficient method for determining a corner video part of a partition of a video coding block.

This object is achieved by the features of the independent claims. Further implementation forms are apparent from the dependent claims, the description and the figures.

The invention is based on the finding that a corner video part of a partition can be determined by successively scanning video parts of the video coding block according to a predetermined scanning pattern. The corner video part is detected when firstly arriving at a video part arranged within the partition. Therefore, not all video parts of the partition have to be processed. Furthermore, the scanning of the video parts can efficiently be implemented.

According to a first aspect, embodiments relate to a method for determining a corner video part of a partition of a video coding block, the video coding block comprising a plurality of video parts. The method comprises selecting a video part of the video coding block according to a predetermined scanning pattern to obtain a selected video part, wherein the predetermined scanning pattern indicates a scanning order of the video parts in the video coding block. The method also comprises determining whether the selected video part is arranged within the partition, and determining the selected video part as the corner video part if the selected video part is arranged within the partition.

The video coding block can relate to a macro-block or a coding unit. The partition of the video coding block can be arbitrarily shaped. The shape of the partition can be e.g. regular, i.e. rectangular, or irregular, i.e. non-rectangular.

The video part can comprise a pixel or a group of pixels. The group of pixels can e.g. comprise 2×2 pixels, 4×4 pixels, or 8×8 pixels. A pixel can be represented as a sample value.

The corner video part can e.g. be a left top corner video part, a right top corner video part, a left bottom corner video part, or a right bottom corner video part. The corner video part can relate to a video part located at an edge of the partition.

The corner video part can be a single pixel or a group of pixels. The location of the corner video part can be determined in terms of an address, a row, and/or a column of the corner video part within the video coding block.

In case of an HEVC codec, an address of a group of 4×4 pixels can be determined. A neighboring reference block or a neighboring reference partition can then be determined upon the basis of the determined address of the group of 4×4 pixels.

The predetermined scanning pattern can be a horizontal scanning pattern, a vertical scanning pattern, or a zig-zag scanning pattern. The left top video part, the right top video part, the left bottom video part, or the right bottom video part of the video coding block can be used as a start of the predetermined scanning pattern. The predetermined scanning pattern can define whether the corner video part forms a left top corner video part, a right top corner video part, a left bottom corner video part, or a right bottom corner video part of the partition of the video coding block.

The arrangement of the selected video part within the partition can relate to a logical mapping of the selected video part onto the partition. The determining whether the selected video part is arranged within the partition can also be performed by determining whether the selected video part belongs to or is associated with the partition.

According to a first implementation form of the method according to the first aspect as such, the method further comprises determining a further video part upon the basis of the predetermined scanning pattern if the selected video part is not arranged within the partition, the further video part forming a selected video part, determining whether the selected video part is arranged within the partition, and determining the selected video part as the corner video part if the selected video part is arranged within the partition. Thus, a further video part of the video coding block can be scanned according to the predetermined scanning pattern.

According to a second implementation form of the method according to the first aspect as such or the first implementation form of the first aspect, the video part comprises a pixel or a group of pixels, in particular a group of 4×4 pixels. Thus, the coding performance can be adjusted.

According to a third implementation form of the method according to the first aspect as such or any preceding implementation form of the first aspect, the partition of the video coding block has an irregular, in particular a non-rectangular, shape. Thus, the coding performance can be increased with respect to regular, in particular rectangular, shaped partitions.

According to a fourth implementation form of the method according to the first aspect as such or any preceding implementation form of the first aspect, the partition of the video coding block is determined by a partitioning mask, the partitioning mask indicating the video parts of the partition by a predetermined numerical value, and wherein the method comprises determining whether the selected video part is arranged within the partition upon the basis of the partitioning mask. Thus, an arrangement of the selected video part within the partition can efficiently be determined.

The partitioning mask can be a pixel-wise partitioning mask. The partitioning mask can also be a down-sampled partitioning mask to provide a partitioning mask for a group of pixels, in particular a group of 2×2, 4×4, or 8×8 pixels.

The predetermined numerical value of the partition can be a natural number, e.g. 128.

According to a fifth implementation form of the method according to the fourth implementation form of the first aspect, determining whether the selected video part is arranged within the partition is performed by comparing a numerical value of the selected video part within the partitioning mask with the predetermined numerical value of the partition within the partitioning mask. Thus, an arrangement of the selected video part within the partition can be determined efficiently.

The numerical value of the selected video part can be a natural number, e.g. 112. In case that the numerical value of the selected video part is identical to the predetermined numerical value of the partition, it can be determined that the selected video part is arranged within the partition.

According to a sixth implementation form of the method according to the fourth implementation form or the fifth implementation form of the first aspect, the method further comprises down-sampling of the partitioning mask by a predetermined down-sampling factor. Thus, an address of a group of pixels of a video part can be determined instead of an address of a single pixel of a video part.

The down-sampling of the partitioning mask can comprise a low-pass filtering of the partitioning mask. The down-sampling can be performed on a group of pixels, in particular a group of 2×2, 4×4, or 8×8 pixels.

The predetermined down-sampling factor can indicate a down-sampling ratio along a horizontal and/or vertical axis of the video coding block. The predetermined down-sampling factor can be a natural number, e.g. 2, 4, or 8.

According to a seventh implementation form of the method according to the first aspect as such or any preceding implementation form of the first aspect, a left top corner video part of the partition is determined using a Horizontal Left-Right-Top-Bottom (HLRTB) scanning pattern, a Vertical Top-Bottom-Left-Right (VTBLR) scanning pattern, a Horizontal Zig-Zag Left-Top (HZZLT) scanning pattern, or a Vertical Zig-Zag Left-Top (VZZLT) scanning pattern. Thus, the left top corner video part can be determined efficiently.

According to an eighth implementation form of the method according to the first aspect as such or any preceding implementation form of the first aspect, a right top corner video part of the partition is determined using a Horizontal Right-Left-Top-Bottom (HRLTB) scanning pattern, a Vertical Top-Bottom-Right-Left (VTBRL) scanning pattern, a Horizontal Zig-Zag Right-Top (HZZRT) scanning pattern, or a Vertical Zig-Zag Right-Top (VZZRT) scanning pattern. Thus, the right top corner video part can be determined efficiently.

According to a ninth implementation form of the method according to the first aspect as such or any preceding implementation form of the first aspect, a left bottom corner video part of the partition is determined using a Horizontal Left-Right-Bottom-Top (HLRBT) scanning pattern, a Vertical Bottom-Top-Left-Right (VBTLR) scanning pattern, a Horizontal Zig-Zag Left-Bottom (HZZLB) scanning pattern, or a Vertical Zig-Zag Left-Bottom (VZZLB) scanning pattern. Thus, the left bottom corner video part can be determined efficiently.

According to a tenth implementation form of the method according to the first aspect as such or any preceding implementation form of the first aspect, a right bottom corner video part of the partition is determined using a Horizontal Right-Left-Bottom-Top (HRLBT) scanning pattern, a Vertical Bottom-Top-Right-Left (VBTRL) scanning pattern, a Horizontal Zig-Zag Right-Bottom (HZZRB) scanning pattern, or a Vertical Zig-Zag Right-Bottom (VZZRB) scanning pattern. Thus, the right bottom corner video part can be determined efficiently.

According to an eleventh implementation form of the method according to the first aspect as such or any preceding implementation form of the first aspect, the selected video part is selected at a row or a column of a previously determined corner video part of the partition of the video coding block. Thus, the number of video parts to be scanned can be reduced.

The row can define a number of horizontally arranged video parts. The column can define a number of vertically arranged video parts.

If both HLRTB and HRLTB scanning patterns are used, the row selected by one scan can be used as a starting point for the other scan.

If both HLRBT and HRLBT scanning patterns are used, the row selected by one scan can be used as a starting point for the other scan.

If both VTBLR and VBTLR scanning patterns are used, the column selected by one scan can be used as a starting point for the other scan.

If both VRLTB and VBTRL scanning patterns are used, the column selected by one scan can be used as a starting point for the other scan.

Consequently, a starting point of the predetermined scanning pattern can be determined based on the location of a previously determined corner video part. The starting point of the predetermined scanning pattern can then be located at a row and/or a column of the previously determined corner video part.

According to a second aspect, embodiments relate to a video coder for coding a video signal, the video signal comprising a number of video coding blocks, the video coder comprising a processor being configured to determine a corner video part of a partition of a video coding block, the video coding block comprising a plurality of video parts, the processor being further configured to select a video part of the video coding block according to a predetermined scanning pattern to obtain a selected video part, wherein the predetermined scanning pattern indicates a scanning order of the video parts in the video coding block, to determine whether the selected video part is arranged within the partition, and to determine the selected video part as the corner video part if the selected video part is arranged within the partition.

The video coder can be a video encoder for encoding the video signal. The video coder can be a video decoder for decoding the video signal. The coding can be an encoding or a decoding. The processor can be configured to execute a computer program.

The video coder can be configured to perform the method for determining a corner video part of a partition of a video coding block according to the first aspect as such or any implementation form of the first aspect.

Further features of the video coder can directly result from the functionality of the method for determining a corner video part of a partition of a video coding block according to the first aspect as such or any implementation form of the first aspect.

According to a first implementation form of the video coder according to the second aspect as such, the processor is further configured to determine a further video part upon the basis of the predetermined scanning pattern if the selected video part is not arranged within the partition, the further video part forming a selected video part, to determine whether the selected video part is arranged within the partition, and to determine the selected video part as the corner video part if the selected video part is arranged within the partition. Thus, a further video part of the video coding block can be scanned according to the predetermined scanning pattern.

According to a third aspect, embodiments relate to a computer program for performing the method according to the first aspect as such or any implementation form of the first aspect when executed on a computer. Thus, the method can be applied in an automatic and repeatable manner.

The computer program can be provided in form of a machine-readable code. The computer program can comprise a series of commands for a processor of the computer. The processor of the computer can be configured to execute the computer program.

The computer can comprise a processor, a memory, and/or input/output means.

The computer program can be executed by the processor of the video coder according to the second aspect as such or any implementation form of the second aspect.

The invention can be implemented in hardware and/or software.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a schematic diagram of a method for determining a corner video part of a partition of a video coding block according to an implementation form;

FIG. 2 shows a schematic diagram of a video coder for coding a video signal according to an implementation form;

FIG. 3 shows a schematic diagram of neighboring video coding blocks regarded as potential reference video coding blocks for predictive video coding according to an implementation form;

FIG. 4 shows a schematic diagram of a depth-based block partitioning (DBBP) scheme according to an implementation form;

FIG. 5 shows a schematic diagram of a superposition of conventional partitioning modes and depth-based block partitioning according to an implementation form;

FIG. 6 shows a schematic diagram of raster scanning orders for determining corners of irregular shape partitions according to an implementation form;

FIG. 7 shows a schematic diagram of zig-zag scanning orders for determining corners of irregular shape partitions according to an implementation form;

FIG. 8 shows a schematic diagram of determined corners of irregular shape partitions according to an implementation form; and

FIG. 9 shows a schematic diagram of an encoding of a texture block using DBBP partitioning according to an implementation form.

### DETAILED DESCRIPTION OF ILLUSTRATIVE EMBODIMENTS

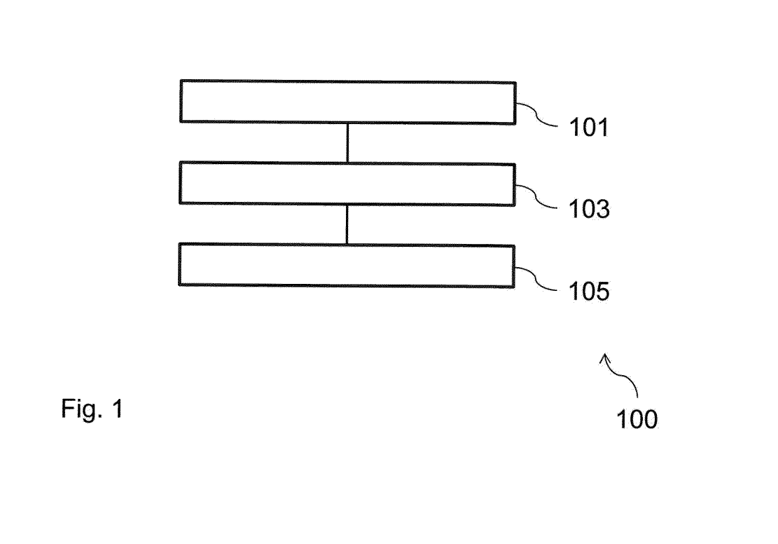

FIG. 1 shows a schematic diagram of a method 100 for determining a corner video part of a partition of a video coding block according to an implementation form. The video coding block comprises a plurality of video parts.

The method 100 comprises selecting 101 a video part of the video coding block according to a predetermined scanning pattern to obtain a selected video part, wherein the predetermined scanning pattern indicates a scanning order of the video parts in the video coding block, determining 103 whether the selected video part is arranged within the partition, and determining 105 the selected video part as the corner video part if the selected video part is arranged within the partition.

The video coding block can relate to a macro-block or a coding unit. The partition of the video coding block can be arbitrarily shaped. The shape of the partition can be e.g. regular, i.e. rectangular, or irregular, i.e. non-rectangular.

The video part can comprise a pixel or a group of pixels. The group of pixels can e.g. comprise 2×2 pixels, 4×4 pixels, or 8×8 pixels. A pixel can be represented as a sample value.

The corner video part can e.g. be a left top corner video part, a right top corner video part, a left bottom corner video part, or a right bottom corner video part. The corner video part can relate to a video part located at an edge of the partition.

The corner video part can be a single pixel or a group of pixels. The location of the corner video part can be determined in terms of an address, a row, and/or a column of the corner video part within the video coding block.

In case of an HEVC codec, an address of a group of 4×4 pixels can be determined. A neighboring reference block or a neighboring reference partition can then be determined upon the basis of the determined address of the group of 4×4 pixels.

The predetermined scanning pattern can be a horizontal scanning pattern, a vertical scanning pattern, or a zig-zag scanning pattern. The left top video part, the right top video part, the left bottom video part, or the right bottom video part of the video coding block can be used as a start of the predetermined scanning pattern. The predetermined scanning pattern can define whether the corner video part forms a left top corner video part, a right top corner video part, a left bottom corner video part, or a right bottom corner video part of the partition of the video coding block.

The arrangement of the selected video part within the partition can relate to a logical mapping of the selected video part onto the partition. The determining whether the selected video part is arranged within the partition can also be performed by determining whether the selected video part belongs to or is associated to the partition.

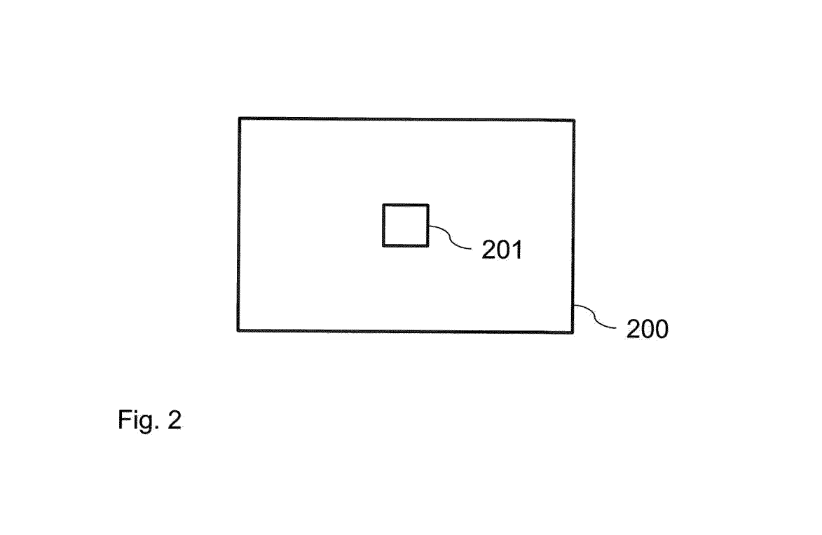

FIG. 2 shows a schematic diagram of a video coder 200 for coding a video signal according to an implementation form. The video signal comprises a number of video coding blocks.

The video coder 200 comprises a processor 201 being configured to determine a corner video part of a partition of a video coding block, the video coding block comprising a plurality of video parts, the processor 201 being further configured to select a video part of the video coding block according to a predetermined scanning pattern to obtain a selected video part, wherein the predetermined scanning pattern indicates a scanning order of the video parts in the video coding block, to determine whether the selected video part is arranged within the partition, and to determine the selected video part as the corner video part if the selected video part is arranged within the partition.

The video coder 200 can be a video encoder for encoding the video signal or a video decoder for decoding the video signal. The coding can be an encoding or a decoding. The processor 201 can be configured to execute a computer program.

The video coder 200 can be configured to perform the method for determining a corner video part of a partition of a video coding block.

Further features of the video coder 200 can directly result from the functionality of the method for determining a corner video part of a partition of a video coding block.

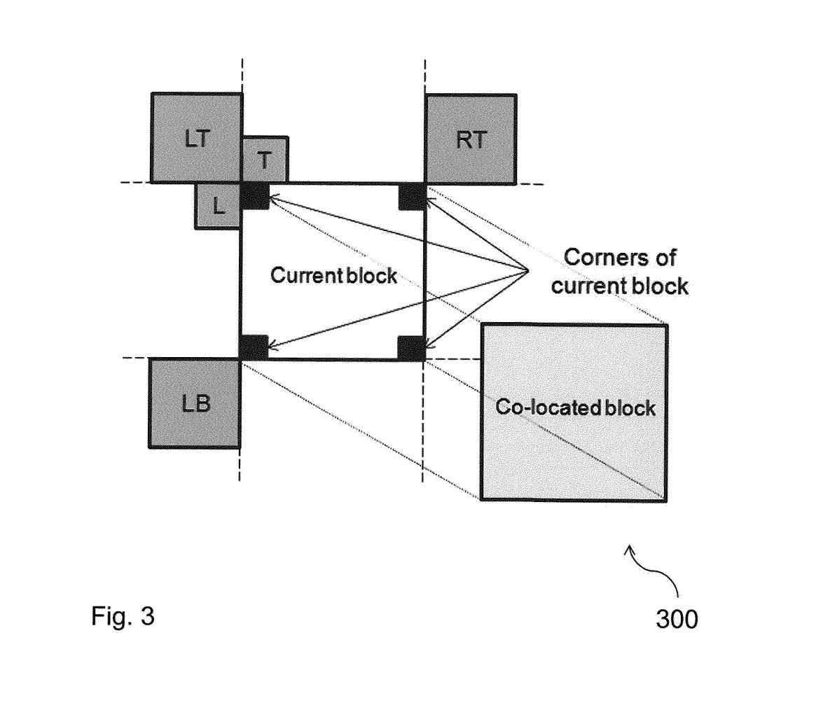

FIG. 3 shows a schematic diagram 300 of neighboring video coding blocks regarded as potential reference video coding blocks for predictive video coding according to an implementation form.

In 3D video coding, depth data can be represented as a set of depth maps that can correspond to each video frame of the texture video. The intensity of each pixel or point of the depth map can describe a distance from the camera of the visual scene represented by this pixel or point. Alternatively, a disparity map can be used. The values of the disparity map can be inversely proportional to the values of the depth map.

In 3D video coding, the depth map for each view can be encoded besides conventional video data. In order to preserve backward compatibility for non-3D codecs, in 3D video codecs texture for the base-view can be encoded first. The order of coding remaining components can be adjusted. There can be two main coding orders utilized: texture-first and depth-first which can provide an opportunity to exploit inter-component, i.e. texture-depth, dependencies to increase the overall coding performance of the 3D video codecs.

Texture-first coding order can enable advanced texture dependent coding tools to be used for coding depth. On the other hand, depth-first coding order can enable advanced depth dependent coding tools for texture coding. In future standards for 3D video coding, e.g. 3D-HEVC, the texture-first coding order can be used in the common test conditions (CTC). However, even in case of texture-first coding there can still be an approximation of the depth map of the coded view available which can be a virtual depth map synthesized from other views or reference views.

In video codecs, an encoded frame or picture can be divided into small parts, called video coding blocks, macro-blocks or coding units. In the coding process, the encoder can decide about a coding mode for each part, including the possibility to divide each part into smaller sub-parts. This process can be referred to as block partitioning. As a result, each video coding block can comprise one or more partitions. In video codecs, a rectangular shape of partitions can be allowed. However, a number of solutions can exist where the shape of partitions can arbitrarily be adjusted to the encoded content. In a specific scheme, irregular shape partitions can be used, called depth-based block partitioning (DBBP). The arbitrary shape of partitions can be determined based on available depth information associated with the coded texture block.

Additionally, for each part or sub-part, a prediction mode can be selected. As predictive coding can be an efficient scheme for encoding video content, for each partition of the coded video coding block a reference block, or a partition of the video coding block if it was further divided, which has already been encoded prior to the coded video coding block, can be selected. Such a video coding block can be set as a reference for the coded video coding block and only a prediction error with respect to this reference block can be signaled in the bit-stream of the encoded video. A reference block can be selected from the video coding blocks of the same frame or picture as the coded video coding block or one of the available previously coded frames or pictures. In the first case, an intra, i.e. intra-picture, prediction can be utilized. In the latter case, an inter, i.e. inter-picture, prediction can be used. In the intra prediction, each partition of the coded video coding block can be predicted using a selected directional predictor.

In the inter prediction, a motion estimation can be applied, which can use motion vectors to specify a spatial location of a reference block in a reference frame or picture relatively to the special position of a coded video coding block in a current frame or picture. Also, the reference frame or picture can be specified, which can be indicated by a reference frame or picture index. For each partition of the coded video coding block, an independent set of motion vectors and reference frame or picture indices can be selected by the encoder. Consequently, the inter prediction of each partition can be different. Finally, a prediction error or residuum, i.e. a difference between a prediction of the coded video coding block and the original coded video coding block can be encoded and transmitted in the bit-stream.

However, even if inter prediction is used for the coded video coding block, some elements describing the encoding of the video coding block can be predicted based on the neighboring reference blocks. This can include e.g. motion vectors. In such a case, a wise prediction of the neighboring reference block can have an impact on the coding performance.

In video codecs, the following neighboring blocks can be concerned as potential reference blocks to be selected. The neighboring to be considered as a reference for a currently coded video coding block can be: left (L), top (T), left-top (LT), left-bottom (LB), right-top (RT) and co-located blocks or their partitions if the video coding blocks have been further divided. Here, the co-located block can be a video coding block with the same special position in the frame or picture as the coded video coding block, but located in other frame or picture which has been coded prior to the current frame or picture and can be available for prediction.

In order to determine the position of the neighboring block, i.e. candidates to be used as reference for prediction, the corners of the coded video coding block can be used. In this way, positions of left-top (LT), left-bottom (LB), right-top (RT) and right-bottom (RB) corners of the coded video coding block or partition of the coded video coding block can be utilized. Based on the location of the corners, the reference blocks can be selected with respect to their availability, coding mode and assigned values of specific elements, e.g. reference frame or picture indices or motion vectors. The relation between usage of each corner position and the neighboring block can be the following: LT corner relates to a selection of an L or/and an LT neighboring block, LB corner relates to a selection of an L or/and an LB neighboring block, RT corner relates to a selection of a T or/and an LT neighboring block, or RB corner relates to a selection of a co-located block.

The term “corners of the current video coding block” can be used as the coded video coding block or partition of the coded video coding block can have a rectangular shape. This can be the case for specific video codecs. However, in case of irregular shape partitions, parts of such partition that can be appropriate for locating the neighboring reference blocks can also be determined. In order to be consistent with this terminology, these parts of irregular shape partitions can also be referred to as corners.

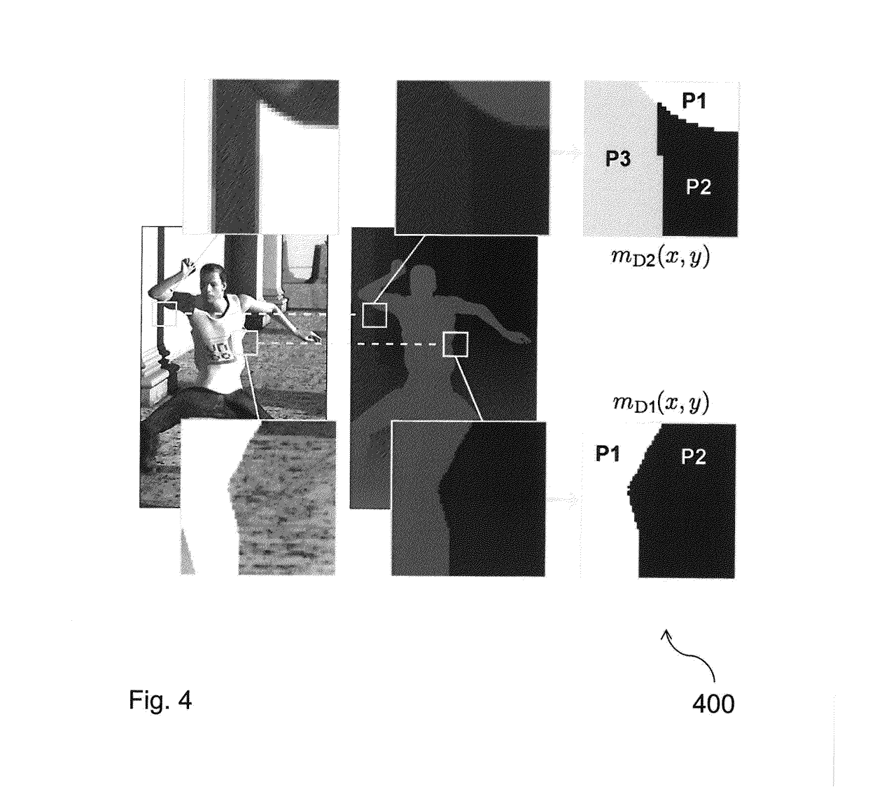

FIG. 4 shows a schematic diagram 400 of a depth-based block partitioning (DBBP) scheme according to an implementation form. The diagram 400 shows from the left a coded texture block, an associated depth information or disparity map and a resultant partitioning in form of a mask comprising two partitions mD1(x,y) and three partitions mD2(x,y).

The combined coding of 3D videos can have the goal to exploit inter-component dependencies to increase the overall coding performance. Both directions, i.e. texture-to-depth and depth-to-texture, can be possible and can result in improving the overall coding efficiency by utilizing inter-component dependencies.

Additionally, the inter-component dependencies can be used to determine an arbitrary shape of partitions of the video coding blocks to further improve compression efficiency by better adjusting the shape of coded partitions or units to an actual shape of an object in the visual scene. For this purpose, it can be deliberate to utilize a depth component to determine the shape of partitions, as the edges in depth maps can well be preserved.

A scheme for determining and utilizing an irregular shape of block partitioning, called depth-based block partitioning (DBBP), can be employed. DBBP can introduce an irregular shape of partitions that can be determined based on depth associated with the coded block to improve the texture coding. Each video coding block in DBBP mode can be divided into a predefined number, e.g. 2, of irregular shape partitions or segments.

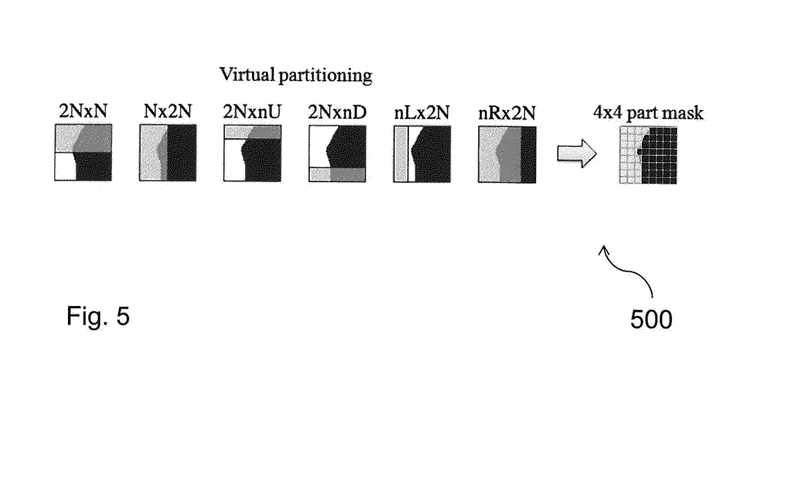

FIG. 5 shows a schematic diagram 500 of a superposition of conventional partitioning modes and depth-based block partitioning according to an implementation form. The conventional partitioning modes are shown in gray. The depth-based block partitioning is shown in black/white. The best matching partitioning, i.e. iopt, mode can be selected to represent an irregular shape partitioning of DBBP.

In DBBP, a pixel-wise mask that can represent an arbitrary shape partitioning can be mapped onto available regular, e.g. rectangular, partitions for storing of the coding information for the coded video coding block, including partitioning, to be easily referenced or used for prediction by latter encoded/decoded video coding blocks. The mapping can be performed by down-sampling an original, i.e. pixel-wise, partitioning mask onto 2×2, 4×4, 8×8, 16×16, 32×32, 64×64, etc. pixel grid or by representing the mask by the most similar regular block partitioning mode for the current level in block-tree used by the codec, i.e. using a so-called virtual partitioning.

Virtual partitioning can reduce the benefit of having irregular partitioning that reflects borders of the objects in a visual scene. However, it can make an implementation of DBBP and its integration with existing codecs, like HEVC, much easier. In particular, determining the corners of virtual partitions to be used for selecting the neighboring reference blocks can be a simple task and schemes used by the codec can be applied. As the virtual partitions can be rectangular, knowledge of a starting position, i.e. a location of the left-top corner of the rectangular partition, and a partition size can be sufficient to locate all the other corners. The position of the left-top corner can be determined by referencing the position of the whole video coding block in the picture and knowing the partition index.

On the other hand, when an approach of down-sampling an original, i.e. pixel-wise, partitioning mask onto a smaller resolution grid, e.g. 2×2, 4×4, 8×8, 16×16, 32×32, 64×64, etc. pixels, is utilized, a determination of neighboring reference blocks in case of irregular shape partitions of DBBP block can become a non-trivial task. As the shape of the resultant partitions may no longer be defined by the position of a left-top corner of the video coding block, a partition size and partition index within the video coding block or other schemes for determining the corners of the coded DBBP video coding block can be applied.

A number of schemes from computer graphics and image processing for determining corner-like shapes can be applied. These schemes can be applied directly on the smaller resolution grid produced by down-sampling the original, i.e. pixel-wise, partitioning mask of DBBP. Especially schemes based on image filtering with corner detection can be applied.

A specific scheme relates to corner detection using chain codes and corner-like patterns matching. A further specific scheme relates to a corner detector for detecting image areas with a high gradient in two orthogonal directions.

Also, schemes like tessellation, comprising an approximation of a shape of an object with smaller, regular-shape patterns, e.g. triangles or rectangles, can be applied. In this approach, each regular pattern can be analyzed to detect its corners. Finally, corners that fulfill the specified properties for determining the neighboring blocks can be selected among all identified corners.

Solutions for determining the corners of irregular shape partitions of a coded video coding block, used for a selection of neighboring reference blocks, can be based on representing the partitioning mask as most similar rectangular partitioning mode. This can reduce the benefits of using irregular shape partitions and can influence the coding performance.

Additionally, among schemes for detecting corner-like patterns in irregular shapes, the schemes can be based on complex computations like filtering of pixels of the mask or accessing or searching all the pixels or points of the mask. Such schemes can be challenging in case of usage in task of selecting a neighboring reference block for video coding purposes, due to a resultant non-negligible computational complexity increase.

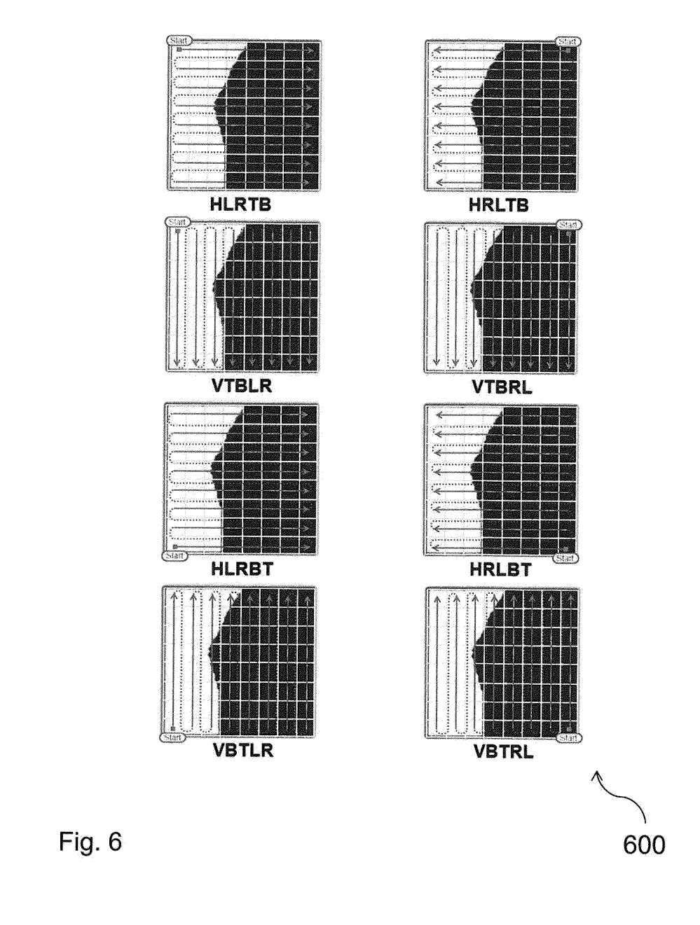

FIG. 6 shows a schematic diagram 600 of raster scanning orders for determining corners of irregular shape partitions according to an implementation form.

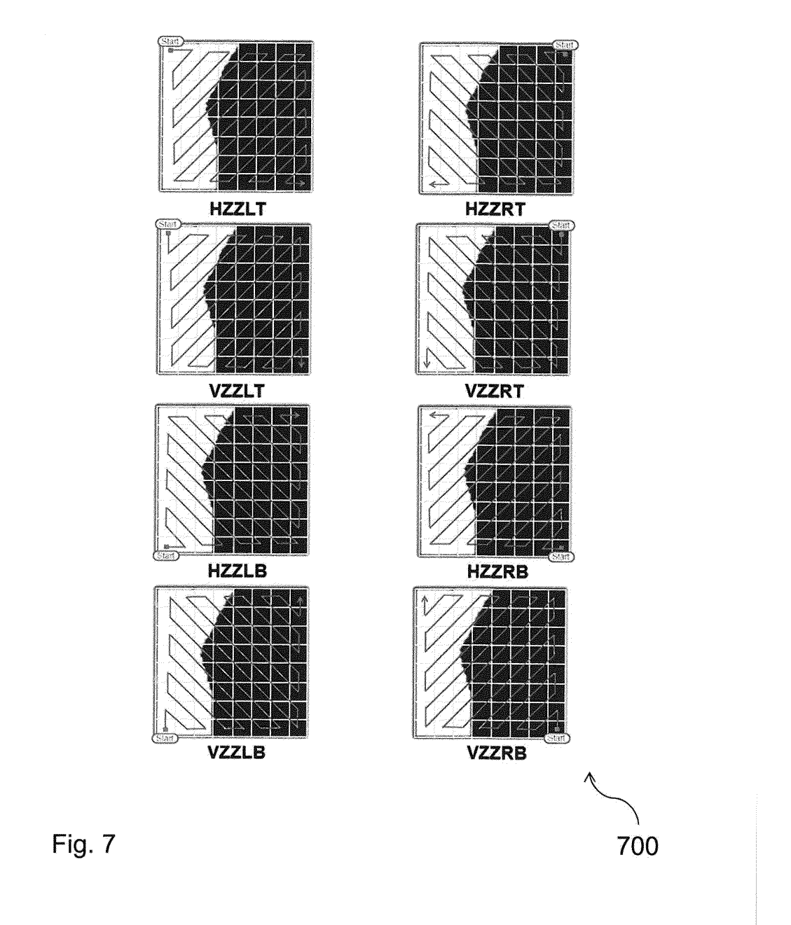

FIG. 7 shows a schematic diagram 700 of zig-zag scanning orders for determining corners of irregular shape partitions according to an implementation form.

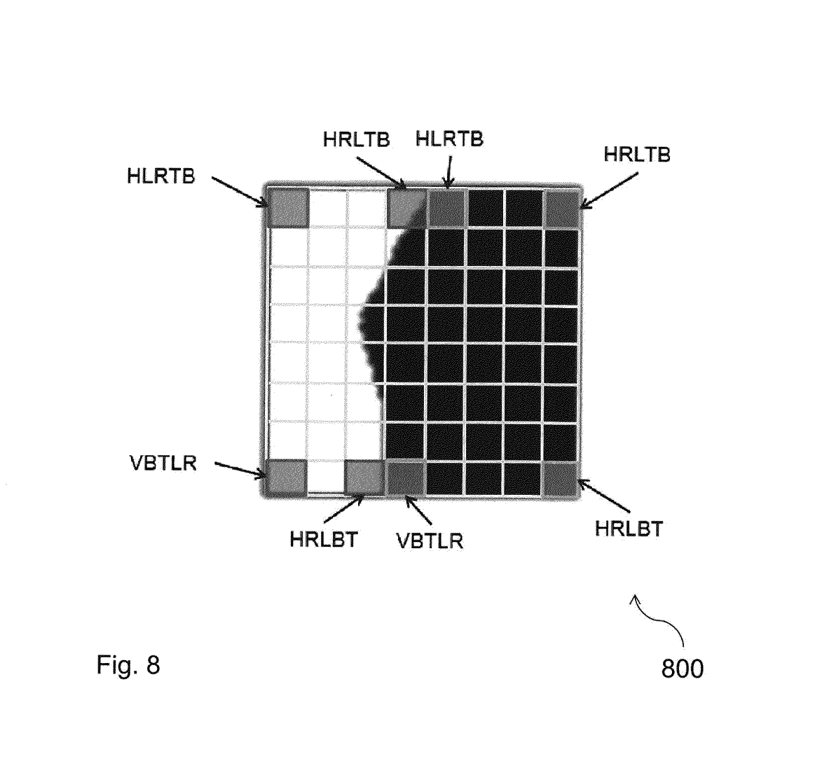

FIG. 8 shows a schematic diagram 800 of determined corners of irregular shape partitions according to an implementation form.

A method of determining the left top (LT), right top (RT), left bottom (LB) and right bottom (RB) corners of irregular shape partitions of a coded video coding block that are used to select neighboring reference blocks utilized for prediction in video coding can be applied.

Information describing the irregular shape of partitions, in particular, a partitioning mask or a down-sampled partitioning mask, can be searched using a scanning order in order to determine each corner, i.e. the position in the irregular shape partition, according to which a neighboring reference block can be located. A number of scanning orders dedicated for determining different neighboring reference blocks can be applied. Finally, schemes to decrease the complexity of determining the corners of the irregular shape partitions can be applied.

A method for determining the left top (LT), right top (RT), left bottom (LB) and right bottom (RB) corners of the irregular shape partitions of the coded video coding block based on which the neighboring reference blocks are selected for the purpose of prediction in video coding can be performed as follows.

Each of the corners of the irregular shape partition can be determined using a dedicated scanning order that can be chosen as a most proper one in terms of selection of the neighboring reference blocks. Using the selected scanning order, the partitioning mask describing the irregular shape partition can be scanned. The corner can be determined to be an element of the partitioning mask that belongs to the selected partition that has firstly been approached when scanning with the given scanning order.

Different scanning orders can be applied for selecting left top (LT), right top (RT), left bottom (LB) and right bottom (RB) corners of the irregular shape partitions. The scanning orders are listed below.

For determining an LT corner a Horizontal Left-Right-Top-Bottom scan (HLRTB scan), or a Vertical Top-Bottom-Left-Right scan (VTBLR scan), or a Horizontal Zig-Zag Left-Top scan (HZZLT scan), or a Vertical Zig-Zag Left-Top scan (VZZLT scan) can be used.

For determining a RT corner a Horizontal Right-Left-Top-Bottom scan (HRLTB scan), or a Vertical Top-Bottom-Right-Left scan (VRLTB scan), or a Horizontal Zig-Zag Right-Top scan (HZZRT scan), or a Vertical Zig-Zag Right-Top scan (VZZRT scan) can be used.

For determining a LB corner a Horizontal Left-Right-Bottom-Top scan (HLRBT scan), or a Vertical Bottom-Top-Left-Right scan (VBTLR scan), or a Horizontal Zig-Zag Left-Bottom scan (HZZLB scan), or a Vertical Zig-Zag Left-Bottom scan (VZZLB scan) can be used.

For determining a RB corner a Horizontal Right-Left-Bottom-Top scan (HRLBT scan), or a Vertical Bottom-Top-Right-Left scan (VBTRL scan), or a Horizontal Zig-Zag Right-Bottom scan (HZZRB scan), or a Vertical Zig-Zag Right-Bottom scan (VZZRB scan) can be used.

The abovementioned scanning orders for determining the corners of irregular shape partitions in order to select neighboring reference blocks are shown in detail in the figures. Further scanning orders based on raster or zig-zag scanning can also be applied.

The selection of the schemes can result from an evaluation using common test conditions (CTC) e.g. of the JCT-3V group. The performance of the scanning orders can be compared against other solutions.

A further scanning order that can be used includes a full-search comprising an exhaustive scanning of all elements in the partitioning mask and selecting a location or position that belongs to the partition and is closest to the selected corner of the coded rectangular block.

These schemes can provide a slightly better coding performance but can be more computationally complex.

The way in which the scanning order is used for determining the specified corner can be pre-selected, adaptively selected or signaled explicitly. In case of pre-selection or adaptive selection of the scanning order in the encoder, no additional information may be signaled to the decoder. On the other hand, if the encoder uses explicit signaling of selected scanning orders, this information can be signaled to the decoder. This information can be switchable per sequence, per GOP, per Intra-period, per picture, per slice, per coding unit and/or per partition.

The scheme for determining the corners of irregular shape partitions can be applied using both a pixel-wise partitioning mask, e.g. a pixel-wise segmentation mask of the DBBP, or its down-sampled version, i.e. 2×2, 4×4, 8×8, 16×16, 32×32, 64×64, etc. pixel grid, e.g. a part-wise segmentation mask of the DBBP, wherein part can mean a 4×4-pixel group or unit.

Schemes for minimizing the complexity of determining the corners of irregular shape partitions can be applied as follows.

If both HLRTB and HRLTB scanning orders are used, the row selected by one scan can be used as a starting point for search in another scan.

If both HLRBT and HRLBT scanning orders are used, the row selected by one scan can be used as a starting point for search in another scan.

If both VTBLR and VBTLR scanning orders are used, the column selected by one scan can be used as a starting point for search in another scan.

If both VTBRL and VBTRL scanning orders are used, the column selected by one scan can be used as a starting point for search in another scan.

The advantages of the scheme can be summarized as follows. The scheme can provide a more accurate corner detection of a DBBP segment in a coded video coding block than schemes used for rectangular shape partitions. The scheme can provide a low complexity solution for corner detection of irregular shape partition, wherein scanning of all pixels or points in the video coding block or filtering can be omitted. The scheme can easily be adapted to specific algorithms, e.g. of future 3D-HEVC or 3D-AVC standards.

In particular, the scheme of determining corners of irregular shape partitions can be used for motion prediction and coding in AVC or HEVC video codec and their multi-view or 3D variants. In this case, determining prediction candidates for creating an advanced motion prediction (AMVP) candidate list, a merge candidate list or determining neighboring blocks for median prediction of motion vectors can be performed using the scheme of determining corners of irregular shape partitions.

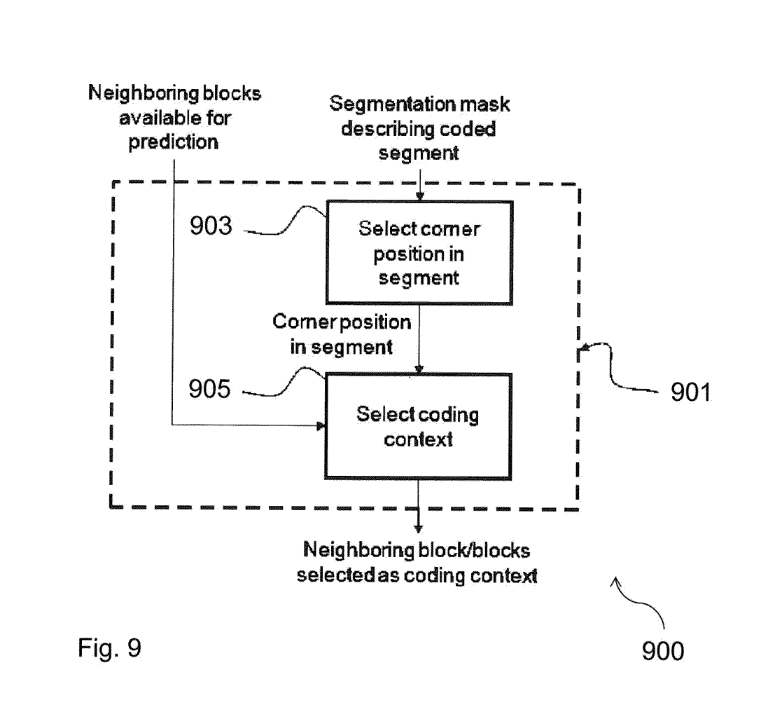

FIG. 9 shows a schematic diagram 900 of an encoding of a texture block using DBBP partitioning according to an implementation form.

The scheme for determining the coding context for irregular shape partitions is shown in block 901. In block 903, the position of a selected corner, i.e. LT, RT, LB or RB, of the coded partition or segment can be determined. In block 905, a neighboring block or neighboring blocks used as a context for coding of the partition or segment can be selected.

According to an implementation form, the invention relates to the field of computer vision, in particular to the field referred to as 3D video processing and 3D video coding.

According to an implementation form, the invention relates to a method for determining the location or position of corners of an irregular shape partition of a coded video coding block based on which the neighboring reference blocks are selected for the purpose of prediction in video coding, comprising scanning the partitioning mask with a predetermined scanning order, and selecting the first element of the partitioning or segmentation mask that belongs to the partition as a corner.

According to an implementation form, the invention relates to a method of determining corners of irregular shape partitions using a pixel-wise partitioning mask.

According to an implementation form, the invention relates to a method of determining corners of irregular shape partitions using a down-sampled partitioning mask, e.g. a 2×2, 4×4, 8×8, 16×16, 32×32, 64×64, etc. pixel grid.

According to an implementation form, the invention relates to a method for determining an LT corner using a Horizontal Left-Right-Top-Bottom scan (HLRTB scan).

According to an implementation form, the invention relates to a method for determining an LT corner using a Vertical Top-Bottom-Left-Right scan (VTBLR scan).

According to an implementation form, the invention relates to a method for determining an LT corner using a Horizontal Zig-Zag Left-Top scan (HZZLT scan).

According to an implementation form, the invention relates to a method for determining an LT corner using a Vertical Zig-Zag Left-Top scan (VZZLT scan).

According to an implementation form, the invention relates to a method for determining a RT corner using a Horizontal Right-Left-Top-Bottom scan (HRLTB scan).

According to an implementation form, the invention relates to a method for determining a RT corner using a Vertical Top-Bottom-Right-Left scan (VTBRL scan).

According to an implementation form, the invention relates to a method for determining a RT corner using a Horizontal Zig-Zag Right-Top scan (HZZRT scan).

According to an implementation form, the invention relates to a method for determining a RT corner using a Vertical Zig-Zag Right-Top scan (VZZRT scan).

According to an implementation form, the invention relates to a method for determining an LB corner using a Horizontal Left-Right-Bottom-Top scan (HLRBT scan).

According to an implementation form, the invention relates to a method for determining an LB corner using a Vertical Bottom-Top-Left-Right scan (VBTLR scan).

According to an implementation form, the invention relates to a method for determining an LB corner using a Horizontal Zig-Zag Left-Bottom scan (HZZLB scan).

According to an implementation form, the invention relates to a method for determining an LB corner using a Vertical Zig-Zag Left-Bottom scan (VZZLB scan).

According to an implementation form, the invention relates to a method for determining a RB corner using a Horizontal Right-Left-Bottom-Top scan (HRLBT scan).

According to an implementation form, the invention relates to a method for determining a RB corner using a Vertical Bottom-Top-Right-Left scan (VBTRL scan).

According to an implementation form, the invention relates to a method for determining a RB corner using a Horizontal Zig-Zag Right-Bottom scan (HZZRB scan).

According to an implementation form, the invention relates to a method for determining a RB corner using a Vertical Zig-Zag Right-Bottom scan (VZZRB scan).

According to an implementation form, the invention relates to methods for minimizing the complexity of determining the corners of irregular shape partitions.

According to an implementation form, use the row selected by one scan as a starting point for search in another scan if both HLRTB and HRLTB scanning orders are used.

According to an implementation form, use the row selected by one scan as a starting point for search in another scan if both HLRBT and HRLBT scanning orders are used.

According to an implementation form, use the column selected by one scan as a starting point for search in another scan if both VTBLR and VBTLR scanning orders are used.

According to an implementation form, use the column selected by one scan as a starting point for search in another scan if both VTBRL and VBTRL scanning orders are used.

The following abbreviations are used: AVC relates to Advanced Video Coding, HEVC relates to High-Efficiency Video Coding, CU relates to Coding Unit, DBBP relates to Depth-Based Block Partitioning, DLT relates to Depth Lookup Table, GOP relates to Group of Pictures, RAP relates to Random Access Point, SEI relates to Supplemental Enhancement Information, SH relates to Slice Header, SPS relates to Sequence Parameter Set, PPS relates to Picture Parameter Set.

The following definitions are used: A video sequence relates to a set of subsequent frames presenting motion picture. 3D video relates to a signal comprising two texture views and their corresponding depth or disparity maps. A visual scene relates to a real world or synthetic scene that is represented in 3D video. A depth map relates to a gray scale picture in which value of every point of the picture determines distance to the camera of the visual scene represented by this point. Alternatively, a disparity map can be used, which values can be inversely proportional to the ones of the depth map. A texture view relates to a video acquired in a specified viewpoint, comprising information about color and texture of the visual scene, usually represented in RGB or YUV format. A random access point relates to a defined point in the structure of a video sequence from which a decoder is able to start decoding the sequence without the knowledge of the previous part of the video stream. SPS relates to a set of parameters sent in form of an organized message comprising basic information for properly decoding the video stream, it can be signaled at the beginning of every random access point. PPS relates to a set of parameters sent in form of an organized message comprising basic information for properly decoding a picture in the video sequence. GOP relates to one of the basic data structures of the video sequence, comprising a predefined number of subsequent pictures that are non-necessarily ordered in the display order. A picture relates to a structure of the video sequence comprising a whole picture of the video sequence, also referred to as a frame. A slice relates to a structure of the video sequence comprising a part of a whole picture of the video sequence. A slice header relates to a set of parameters describing the slice, and can be sent at the beginning of the slice. A CU relates to a basic coding structure of the video sequence of a pre-defined size, comprising a part of a picture, e.g. 64×64 pixels. An I-slice relates to a slice in which all coding units are intra-predicted, so no reference to other pictures may be allowed. SEI relates to a message that can be signaled in a stream of a video sequence, comprising additional or optional information about the video sequence, coding tools etc. A coded block relates to a coding unit, e.g. of regular, rectangular shape, describing an encoded area of the picture using a syntax specified for a coding mode selected for the block. The coding mode describes a set of means and/or a scheme used to encode the coded block of a picture. A reference block relates to a block of a picture which is already decoded prior to a currently processed block and is used as a reference for predictive coding of the current block. A part relates to a smallest size of a regular block partition allowed to be used by the codec, e.g. 4×4 pixels in case of HEVC.

According to an implementation form, the invention relates to a method for locating a location or position of corner partitions in a texture block encoded using depth-based block partitioning (DBBP).

According to an implementation form, the method presents a non-complex algorithm for detecting corner partitions in irregular shape DBBP blocks.

In 3D video, both texture and depth can be present. To preserve backward compatibility for non-3D codecs, texture for the base-view can be encoded first. The order of coding remaining components can be adjusted, e.g. using flexible coding order (FCO) in 3D-HEVC. Texture-first coding order can enable advanced texture dependent depth coding tools. Depth-first coding order can enable advanced depth dependent texture coding tools. Both coding orders can be applicable.

In modern video coding methods, e.g. MPEG-2, AVC or HEVC, the currently processed video coding block can be coded using prediction mechanism to increase the coding performance. In particular, already coded neighboring blocks located above and to the left of the current block can be used for prediction, constituting the context for coding syntax elements, e.g. motion vectors.

The location of the neighboring blocks can be determined based on the location or position of left top (LT), right top (RT), left bottom (LB) and right bottom (RB) corners of the current video coding block.

Block partitioning used in codecs for texture coding can be based on rectangular shapes, i.e. a block divided into rectangular shape partitions. The challenge of finding LT, RT, LB and RB corners of a rectangular partition of known size can be solvable.

The relation between corner and neighbor can be defined as follows. The LT corner relates to a selection of an L/LT neighboring block, the LB corner relates to a selection of an L/LB neighboring block, the RT corner relates to a selection of a T/LT neighboring block, and the RB corner relates to a selection of a collocated block.

A scheme for efficiently signaling an irregular shape of a block partitioning called depth-based block partitioning (DBBP) can be applied. DBBP can introduce an irregular shape of partitions that can be determined based on depth associated with the coded video coding block to improve the texture coding. Each video coding block in DBBP mode can be divided into a predefined number, e.g. 2, of irregular shape partitions or segments.

DBBP can apply virtual partitioning as a simplified approach for representing the irregular shape partitions as one of existing rectangular partitioning schemes for prediction and data storage purposes.

An implementation of DBBP can introduce a more accurate representation. Instead of virtual partitions, a partitioning mask or segmentation mask can be represented as a 4×4 pixels or part mask, i.e. each 4×4-pixel part of the current video coding block can represent data describing a partition or segment assigned to this part. In case of irregular shape partitions, the challenge of determining the corners to locate neighboring blocks used for prediction can be more complex.

Corner detection in irregular shapes can e.g. be performed by image filtering with corner detectors using chain codes and corner-like pattern matching, or a corner detector, or by tessellation as an approximation of the shape with smaller size, regular patterns and analysis of corners of each pattern.

However, there can be a need for addressing the problem of finding the corners of an irregular shape of partitions, determined based on depth to improve the texture coding that can be used to locate the neighboring blocks utilized for prediction of the current video coding block. The scheme may be non-complex and may not be based on searching all pixels or points of the partitioning mask or segmentation mask or 4×4 part mask.

A depth-based block partitioning scanning (DBBP scan) can be applied. The positions of the left top (LT), right top (RT), left bottom (LB) and right bottom (RB) corners of each partition or segment of the current video coding block coded using DBBP mode can be determined by scanning the DBBP partitioning mask or segmentation mask of the current video coding block using one, e.g. preselected, of the scanning orders and selecting the first element of the DBBP partitioning mask or segmentation mask that belongs to the partition or segment, as stop criteria, according to the scanning order as a corner. Different scanning orders can be applied for selecting left top (LT), right top (RT), left bottom (LB) and right bottom (RB) corners.

The depth-based block partitioning scanning (DBBP scan) can be performed as follows.

For an LT corner a Horizontal Left-Right-Top-Bottom scan (HLRTB scan), or a Vertical Top-Bottom-Left-Right scan (VTBLR scan) can be used.

For a RT corner a Horizontal Right-Left-Top-Bottom scan (HRLTB scan), or a Vertical Top-Bottom-Right-Left scan (VTBRL scan) can be used.

For an LB corner a Horizontal Left-Right-Bottom-Top scan (HLRBT scan), or a Vertical Bottom-Top-Left-Right scan (VBTLR scan) can be used.

For a RB corner a Horizontal Right-Left-Bottom-Top scan (HRLBT scan), or a Vertical Bottom-Top-Right-Left scan (VBTRL scan) can be used.

An additional speed-up can be achieved as follows.

If both HLRTB and HRLTB scans are used, the row selected by one scan can be used as a starting point for search in another scan.

If both HLRBT and HRLBT scans are used, the row selected by one scan can be used as a starting point for search in another scan.

If both VTBLR and VBTLR scans are used, the column selected by one scan can be used as a starting point for search in another scan.

If both VTBRL and VBTRL scans are used, the column selected by one scan can be used as a starting point for search in another scan.

The scheme for determining the coding context for irregular shape partitions or segments can comprise determining the position of a selected corner, i.e. LT, RT, LB or RB, of the coded partition or segment, and selecting a neighboring block or neighboring blocks used as a context for coding of the partition or segment.

The scheme can be used for an improved prediction of motion information and can also be applied for prediction of other elements.

The partitioning mask or segmentation mask can comprise a per-pixel partitioning mask or segmentation mask, and/or a partitioning mask or segmentation mask with smaller resolution, e.g. per-part or 4×4 pixels.

According to an implementation form, the invention relates to a method for determining a position of a corner in irregular shape block partitions or segments used for locating neighboring blocks for prediction of the coded block, comprising scanning the partitioning mask or segmentation mask with a predetermined scanning order, and selecting the first element of the partitioning mask or segmentation mask that belongs to the partition or segment as a corner.

A DBBP scan can provide a more accurate corner detection of a DBBP partition or segment in a coded video coding block than schemes used for rectangular shape partitions. It can provide a low complexity solution for corner detection of an irregular shape partition, since scanning of all pixels or points in the video coding block or filtering may not be used. It can be adapted to specific algorithms, e.g. of future 3D-HEVC or 3D-AVC standards.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for determining a corner video part of a partition of a video coding block, the video coding block comprising a plurality of video parts, the method comprising:
selecting a video part of the video coding block according to a predetermined scanning pattern to obtain a selected video part, wherein the predetermined scanning pattern indicates a scanning order of the video parts in the video coding block;
determining whether the selected video part is arranged within the partition; and
determining the selected video part as the corner video part in response to the selected video part being arranged within the partition.

2. The method of claim 1, further comprising:
determining a further video part upon the basis of the predetermined scanning pattern in response to the selected video part being not arranged within the partition, the further video part forming a further selected video part;
determining whether the further selected video part is arranged within the partition; and
determining the further selected video part as the corner video part in response to the further selected video part being arranged within the partition.

3. The method of claim 1, wherein the video part comprises a pixel.

4. The method of claim 1, wherein the video part comprises a group of pixels.

5. The method of claim 1, wherein the video part comprises a group of 4×4 pixels.

6. The method of claim 1, wherein the partition of the video coding block has an irregular shape.

7. The method of claim 1, wherein the partition of the video coding block has a non-rectangular shape.

8. The method of claim 1, wherein the partition of the video coding block is determined by a partitioning mask, the partitioning mask indicating the video parts of the partition by a predetermined numerical value, and wherein the method further comprises determining whether the selected video part is arranged within the partition upon the basis of the partitioning mask.

9. The method of claim 8, wherein determining whether the selected video part is arranged within the partition is performed by comparing a numerical value of the selected video part within the partitioning mask with the predetermined numerical value of the partition within the partitioning mask.

10. The method of claim 8, wherein the method further comprises down-sampling of the partitioning mask by a predetermined down-sampling factor.

11. The method of claim 1, wherein a left top corner video part of the partition is determined using a Horizontal Left-Right-Top-Bottom (HLRTB) scanning pattern, a Vertical Top-Bottom-Left-Right (VTBLR) scanning pattern, a Horizontal Zig-Zag Left-Top (HZZLT) scanning pattern, or a Vertical Zig-Zag Left-Top (VZZLT) scanning pattern.

12. The method of claim 1, wherein a right top corner video part of the partition is determined using a Horizontal Right-Left-Top-Bottom (HRLTB) scanning pattern, a Vertical Top-Bottom-Right-Left (VTBRL) scanning pattern, a Horizontal Zig-Zag Right-Top (HZZRT) scanning pattern, or a Vertical Zig-Zag Right-Top (VZZRT) scanning pattern.

13. The method of claim 1, wherein a left bottom corner video part of the partition is determined using a Horizontal Left-Right-Bottom-Top (HLRBT) scanning pattern, a Vertical Bottom-Top-Left-Right (VBTLR) scanning pattern, a Horizontal Zig-Zag Left-Bottom (HZZLB) scanning pattern, or a Vertical Zig-Zag Left-Bottom (VZZLB) scanning pattern.

14. The method of claim 1, wherein a right bottom corner video part of the partition is determined using a Horizontal Right-Left-Bottom-Top (HRLBT) scanning pattern, a Vertical Bottom-Top-Right-Left (VBTRL) scanning pattern, a Horizontal Zig-Zag Right-Bottom (HZZRB) scanning pattern, or a Vertical Zig-Zag Right-Bottom (VZZRB) scanning pattern.

15. The method of claim 1, wherein the selected video part is selected at a row or a column of a previously determined corner video part of the partition of the video coding block.

16. A video coder for coding a video signal, the video signal comprising a number of video coding blocks, the video coder comprising:
a processor being configured to:
determine a corner video part of a partition of a video coding block, the video coding block comprising a plurality of video parts;
select a video part of the video coding block according to a predetermined scanning pattern to obtain a selected video part, wherein the predetermined scanning pattern indicates a scanning order of the video parts in the video coding block, to determine whether the selected video part is arranged within the partition; and
determine the selected video part as the corner video part in response to the selected video part being arranged within the partition.

17. The video coder of claim 16, the processor being further configured to:
determine a further video part upon the basis of the predetermined scanning pattern in response to the selected video part being not arranged within the partition, the further video part forming a further selected video part;
determine whether the further selected video part is arranged within the partition; and
determine the further selected video part as the corner video part in response to the selected video part being arranged within the partition.
